(19) United States
(12) Patent Application Publication
(10) Pub. No.: US 2025/0348931 A1
(43) Pub. Date: Nov. 13, 2025

(54) PERSONALIZED PAYMENT PLAN SYSTEM FOR PROPERTY MANAGEMENT

(71) Applicant: Entrata, Inc., Lehi, UT (US)

(72) Inventors: Ethan BAHIR, Petach Tikva (IL); Nir OSIROFF, Raanana (IL)

(21) Appl. No.: 19/201,787

(22) Filed: May 7, 2025

Related U.S. Application Data
(60) Provisional application No. 63/643,962, filed on May 8, 2024.

(51) Int. Cl. G06Q 40/03; G06Q 20/10; G06Q 40/02

(52) U.S. Cl. CPC G06Q 40/03; G06Q 20/102; G06Q 40/02

(57) ABSTRACT

Systems and methods are provided for generating and managing personalized payment plans utilizing artificial intelligence (AI). For example, the techniques described herein may support an AI-powered system that generates personalized payment plan options based on (e.g., optimized for) affordability, successful repayment, or both. By analyzing a customer's financial situation, spending habits, creditworthiness, or any combination thereof, the system may tailor the personalized payment plans to individual needs, may adapt to dynamic circumstances, and may predict repayment success with accuracy (e.g., a threshold level of accuracy). This system may be applicable to multiple industries, including, but not limited to, a multi-family housing industry.

### CROSS REFERENCE

The present Application for Patent claims the benefit of U.S. Provisional Patent Application No. 63/643,962 by BAHIR, entitled “PERSONALIZED PAYMENT PLAN SYSTEM FOR PROPERTY MANAGEMENT”, filed May 8, 2024, which is assigned to the assignee hereof, and is expressly incorporated by reference herein.

### BACKGROUND

The present invention relates to the credit risk management and financial inclusion, and more particularly, to AI (artificial intelligence)-based credit risk management and financial inclusion, such as within a domain of property technology (PropTech).

Traditional payment plans often present a one-size-fits-all approach, neglecting individual financial realities and leading to affordability challenges and defaults. Customers increasingly crave flexible and personalized options that align with their unique financial landscapes. Additionally, limitations in existing models include inflexible structures (e.g., an inability to accommodate changing income, expenses, or unforeseen circumstances), limited data consideration (e.g., a reliance solely on traditional credit scores, potentially excluding creditworthy individuals with a limited credit history), a lack of predictive insights (e.g., an inability to asses a likelihood of successful repayment, leading to increased risk for both lenders and borrowers), or any combination thereof.

### SUMMARY

The following is a simplified summary providing an initial understanding of the invention. The summary does not necessarily identify key elements nor limit the scope of the invention, but merely serves as an introduction to the following description.

A method for generating and managing personalized payment plans by a system is described. The method may include acquiring customer data, where the customer data includes financial information, one or more spending habits, demographic information, or any combination thereof, preprocessing the customer data, analyzing the preprocessed customer data using an artificial intelligence (AI) analysis engine, generating a set of multiple candidate payment plans based on the analyzed customer data, adjusting the set of multiple candidate payment plans based on affordability, a probability of successful repayment, or both, displaying the set of multiple candidate payment plans to a customer, monitoring customer behavior, one or more financial circumstances, or both, in real-time, and displaying one or more recommended adjustments to a payment plan from the set of multiple candidate payment plans based on the customer behavior, the one or more financial circumstances, or both.

A system for generating and managing personalized payment plans is described. The system may include data acquisition module configured to collect customer data, where the customer data comprises financial information, one or more spending habits, demographic information, or any combination thereof; a preprocessing module configured to clean, normalize, engineer, or any combination thereof, the customer data; an AI analysis engine configured to analyze the preprocessed customer data, generate a plurality of candidate payment plans, and adjust the plurality of candidate payment plans based on affordability, a probability of successful repayment, or both; a dynamic adaptation module configured to monitor customer behavior, one or more financial circumstances, or both, in real-time; and a user interface configured to display the plurality of candidate payment plans, display progress towards completion of a payment plan from the plurality of candidate payment plans, and receive one or more notifications of one or more recommended adjustments to the payment plan.

A computer-readable medium storing instructions for generating and managing personalized payment plans is described. The instructions may be executable by a processor to acquire customer data, where the customer data includes financial information, one or more spending habits, demographic information, or any combination thereof, preprocess the customer data, analyze the preprocessed customer data using an artificial intelligence (AI) analysis engine, generate a set of multiple candidate payment plans based on the analyzed customer data, adjust the set of multiple candidate payment plans based on affordability, a probability of successful repayment, or both, display the set of multiple candidate payment plans to a customer, monitor customer behavior, one or more financial circumstances, or both, in real-time, and display one or more recommended adjustments to a payment plan from the set of multiple candidate payment plans based on the customer behavior, the one or more financial circumstances, or both.

In some examples of the method, system, and computer-readable medium described herein, the financial information includes one or more bank account details, one or more income statements, one or more creditworthiness scores, one or more existing debt obligations, or any combination thereof.

In some examples of the method, system, and computer-readable medium described herein, the one or more spending habits include a transaction history categorized by one or more spending patterns.

In some examples of the method, system, and computer-readable medium described herein, the demographic information includes age, income level, employment status, or any combination thereof.

Some examples of the method, system, and computer-readable medium described herein may further include operations, features, means, or instructions for securing the customer data in accordance with one or more financial regulations, one or more data privacy regulations, or both. For example, the system may include a security module configured to secure the customer data in accordance with the one or more financial regulations, the one or more data privacy regulations, or both. In some examples of the system described herein, the security module may be configured to secure the customer data using one or more encryption techniques.

In some examples of the method, system, and computer-readable medium described herein, displaying the set of multiple candidate payment plans to the customer may include operations, features, means, or instructions for displaying a message enabling the customer to select the payment plan from the set of multiple candidate payment plans.

In some examples of the system described herein, the AI analysis engine may include one or more supervised learning algorithms trained on one or more historical data sets, where the one or more historical data sets include a set of multiple customer profiles and a respective repayment outcome for each customer profile of the set of multiple customer profiles.

In some examples of the system described herein, the AI analysis engine may include one or more deep learning models configured to extract one or more relationships within the customer data.

In some examples of the system described herein, the dynamic adaptation module may be configured to generate the one or more recommended adjustments to the payment plan based on one or more changes in spending habits, based on one or more income fluctuations, based on one or more financial events, or any combination thereof.

These, additional, and/or other aspects and/or advantages of the present invention are set forth in the detailed description which follows, possibly inferable from the detailed description, and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout. In the accompanying drawings:

FIG. 1 is a high-level block diagram illustrating a system, according to some embodiments of the invention.

FIG. 2 is a high-level flowchart illustrating methods, according to some embodiments of the invention.

FIG. 3 is a high-level block diagram of exemplary controllers, which may be used with embodiments of the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

Existing payment models (e.g., traditional, static payment plans) may struggle with several shortcomings, including, but not limited to, a one-size-fits-all approach, limited adaptability, and lack of predictive insights. For example, the existing payment models may fail to recognize diversity of individual financial circumstances, income levels, spending habits, or any combination thereof, which may lead to plans that are unaffordable or unnecessarily restrictive, ultimately increasing the risk of defaults. In other words, the existing payment models may lead to situations in which a customer struggles to meet repayment obligations due to a mismatch between the customer's financial circumstances and a proposed payment plan, resulting in defaults, negative credit scores, and a strain on a customer-business relationship. Additionally, or alternatively, the existing payment models may be unable to adjust to changing circumstances (e.g., lack flexibility), such as income fluctuations, unexpected expenses, or seasonal variations in income. The lack of flexibility may cause financial strain for customers and limit the customer's ability to manage their payments effectively. Additionally, or alternatively, the existing payment models may be unable to (e.g., or may have difficulty) assessing a likelihood of successful repayment based on credit scores (e.g., traditional credit scores) alone. This can lead to lenders rejecting creditworthy individuals or offering unnecessarily high interest rates due to limited risk assessment capabilities.

Accordingly, techniques described herein may support (e.g., prioritize) affordability, adaptability, and responsible lending practices, fostering a mutually beneficial experience for both customers and business through creation of personalized payment plans with a high (e.g., threshold) likelihood of successful repayment. More specifically, the techniques described herein may leverage artificial intelligence (AI) to create a personalized payment plan system that addresses limitations of the existing payment models by analyzing a range of data points including, but not limited to, a full rent payment ledger, one or more financial situations (e.g., income, expenses, debts, assets, and bank account activity), one or more spending habits (e.g., historical purchasing patterns, budgeting tendencies, and cash flow analysis), creditworthiness (e.g., credit scores, behavioral financial insights, and alternative data, such as payment history, utility bills, and public records), or any combination thereof. For example, the personalized payment plan system described herein may generate dynamic and personalized payment plans that are tailored to a customer (e.g., aligned with each individual's unique financial circumstances, preferences, and risk tolerance), dynamic (e.g., continuously adjust based on real-time data feeds and income fluctuations, ensuring affordability and sustainability), and predictive (e.g., utilizing AI models to simulate and assess repayment success probability with accuracy, mitigating risks for both lenders and customers).

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing”, “deriving” or the like, ref er to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Some embodiments of the present invention provide efficient and economical methods and mechanisms for improved communication, enhanced by AI, and thereby provide improvements to the technological field of AI-based communication systems.

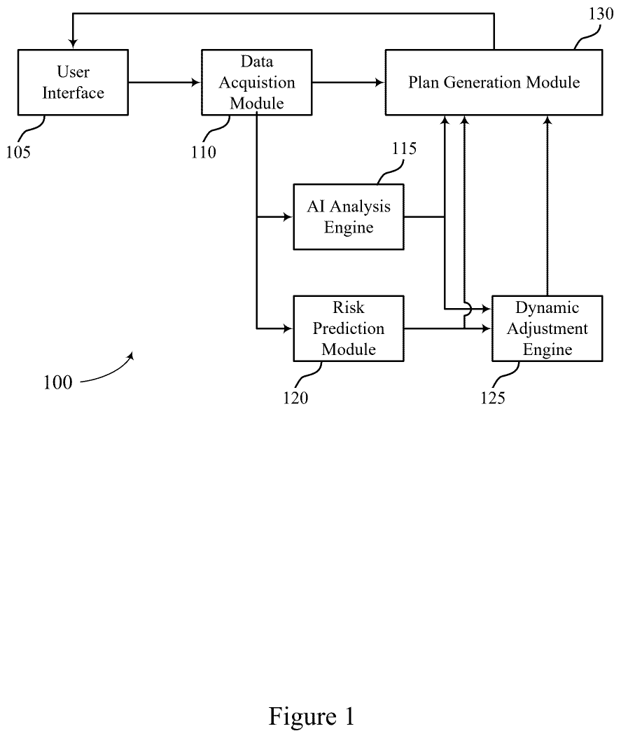

FIG. 1 is a high-level block diagram of a system 100 for generating and managing personalized payment plans utilizing AI, according to some embodiments of the invention. The system 100, as described herein, may include multiple interconnected components, such as a user interface 105, a data acquisition module 110, an AI analysis engine 115, a risk prediction module 120, a dynamic adjustment engine 125, and a plan generation module 130, working in combination to generate and manage personalized payment plans utilizing AI. In some cases, the system 100 may be similarly referred to as the AI engine.

The system 100 may acquire relevant customer data through secure channels with the customer's (e.g., user's) explicit consent. This customer data may encompass a broad spectrum of information, including financial details (bank account details with appropriate anonymization, income statements, creditworthiness scores, and existing debt obligations), spending habits (transaction history categorized by spending patterns to create a comprehensive financial picture), demographic information (age, income level, and employment status), or any combination thereof, that may offer insights into the customer's overall financial context. Once collected, the data may undergo preprocessing to ensure accuracy and consistency. The preprocessing may involve techniques like data cleaning, normalization, feature engineering, or any combination thereof, to prepare the data for utilization by the AI analysis engine 115.

The AI analysis engine 115 may leverage a combination of multiple machine learning (ML) algorithms, such as supervised learning algorithms, deep learning models, or both. Supervised learning algorithms may be trained on historical data sets encompassing multiple (e.g., diverse) customer profiles and their respective repayment outcomes. This training may facilitate the identification of patterns and relationships between customer financial characteristics and successful payment plan completion. Deep learning models may further enhance capabilities of the system 100 by extracting complex and non-linear relationships within the data, leading to personalized and accurate plan generation.

By analyzing the preprocessed customer data, the system 100 may generate (e.g., via the plan generation module 130) multiple potential payment plans tailored to the specific financial circumstances of the individual. These plans may be adjusted (e.g., optimized) for two objectives: affordability and successful repayment. The system 100 may create plans that are comfortably manageable within the customer's budget, minimizing the risk of delinquencies. Additionally, the system 100 may utilize predictive capabilities (e.g., via the risk prediction module 120) to estimate the probability of successful completion for each generated plan. Estimating the probability of successful completion may empower businesses to offer plans with a high likelihood of repayment, fostering responsible lending practices.

The capabilities of the system 100 may extend beyond initial plan generation. For example, the system may include the dynamic adjustment engine 125 (e.g., dynamic adjustment module, dynamic adaptation module) that monitors customer behavior and financial circumstances in real-time. Monitoring customer behavior and financial circumstances in real-time may include tracking changes in spending patterns, income fluctuations, or unexpected financial events. By continually analyzing this dynamic data, the system 100 may proactively recommend adjustments to the existing payment plan, ensuring ongoing affordability and a high success rate for repayment. Additionally, or alternatively, the system 100 may facilitate seamless customer interaction. Customers may access their personalized payment plan details, effortlessly track progress towards completion, and receive timely notifications regarding potential adjustments through the user interface 105, enabling a level of transparency that fosters trust and empowers customers to manage their finances responsibly.

The system 100 may also implement security and compliance considerations when handling customer financial data. For example, the system 100 may adhere to data security protocols and leverages encryption techniques to safeguard sensitive information. Additionally, the system 100 may be designed to operate within the boundaries of relevant financial regulations and data privacy laws.

As described herein, the system 100 may include multiple components that each perform one or more operations that support a function of the system 100 as a whole. For example, the data acquisition module 110 may securely connect to various sources through one or more application programming interfaces (APIs) (e.g., standardized APIs), including, but not limited to, one or more bank accounts, one or more financial institutions, one or credit bureaus, one or more alternative data providers, or any combination thereof. With user consent, the data acquisition module 110 may retrieve income, expenses, transaction history, or any combination thereof, from the one or more bank accounts. The data acquisition module 110 may fetch loan information, one or more credit card statements, investment data, or any combination thereof, from the one or more financial institutions. The data acquisition module 110 may access one or more credit scores, one or more credit report summaries, or both, from the one or more credit bureaus. With user authorization, the data acquisition module 110 may integrate information on one or more utility bills, one or more rental payments, one or more public records, or any combination thereof, from the one or more alternative data providers. In some examples, the data acquisition module 110 may support one or more security measures (e.g., robust security measures), such as encryption, user authentication, or both, to ensure data privacy and compliance with one or more regulations (e.g., relevant regulations).

The AI analysis engine 115 (e.g., a core component, AI analytics) may employ one or more machine learning algorithms (e.g., sophisticated machine learning algorithms) trained on one or more historical data sets (e.g., vast historical data sets). For example, the AI analysis engine 115 may analyze one or more income trends, one or more spending habits, one or more creditworthiness indicators, or any combination thereof, to identify one or more patterns or correlations, which may enable the AI analysis engine 115 to understand individual financial behavior of the user. Additionally, or alternatively, the AI analysis engine 115 may create one or more distinct customer profiles based on one or more respective financial characteristics, one or more respective repayment risk factors, or both, to segment, or categorize, customers. Additionally, or alternatively, the AI analysis engine 115 may utilize one or more forecasting modules (e.g., advanced forecasting modules) to anticipate one or more changes in income (e.g., income streams), potential financial obligations, or both (e.g., predict future income and expenses).

The plan generation module 130 (e.g., plan generator) may leverage one or more insights from AI analysis (e.g., the AI analysis engine 115) to generate various (e.g., multiple, one or more) personalized payment plans for each customer. To generate the various personalized payment plans, the plan generation module 130 may consider affordability, repayment likelihood, customer preferences, or any combination thereof. For example, the plan generation module 130 may tailor plans to fit within (e.g., consider) individual income, essential expenses, debt obligations, or any combination thereof (e.g., data from the data acquisition module 11). Additionally, or alternatively, the plan generation module 130 may utilize one or more AI-powered prediction modules (e.g., from the risk prediction module 120) to assess a probability of successful repayment for each plan (e.g., each plan option). Additionally, or alternatively, the plan generation module 130 may offer flexible terms (e.g., duration, repayment frequency) to align with individual preferences, risk tolerance, or both. Thus, the plan generation module 130 may dynamically generate multiple plan options to provide customers with choices and control over their financial commitments.

The user interface 105 (e.g., an intuitive interface) may enable customers to securely input financial data, view and compare plan options, select and customize plans, monitor progress, or any combination thereof. For example, the user interface 105 may provide a user-friendly platform for data entry with robust security protocols. Additionally, or alternatively, the user interface 105 may present clear visualizations of different plan terms, interest rates, affordability metrics, or any combination thereof. Additionally, or alternatively, the user interface 105 may allow customers to choose a plan and to adjust one or more parameters, such as repayment frequency, down payment, or the like thereof. Additionally, or alternatively, the user interface 105 may offer (e.g., display) a dashboard to trach payment history, manage future payments, receive notifications, or the like thereof. The user interface 105 may offer (e.g., prioritize) transparency, simplicity, and accessibility to empower customers with informed decision-making.

The risk prediction module 120 (e.g., risk predictor) may employ one or more AI models (e.g., advanced AI models) to assess a likelihood of successful repayment for each plan option (e.g., of the multiple plan options generated by the plan generation module 130). The risk prediction module 120 may consider historical data, one or more behavioral finance insights, one or more real-time financial updates, or the like thereof, to assess the likelihood of successful repayment for each plan option. For example, the risk prediction module 120 may analyze historical repayment behavior, credit history, one or more financial stability indicators, or any combination thereof. Additionally, or alternatively, the risk prediction module 120 may incorporate one or more psychological factors, one or more spending patterns, or both, to refine the risk assessment (e.g., the likelihood of successful repayment, risk prediction). Additionally, or alternatively, the risk prediction module 120 may continuously monitor income fluctuations, credit score changes, external events, or any combination thereof, to update the risk assessment. The risk prediction module 120 may safeguard lenders form potential defaults while ensuring responsible lending practices that avoid overextending customers.

The dynamic adjustment engine 125 (e.g., an intelligent feature) may continuously monitor customers' financial data and automatically adjust their plans based on one or more income changes, one or more unexpected expenses, improved credit worthiness, or any combination thereof. For example, the dynamic adjustment engine 125 may adapt one or more plans to align with fluctuations in income, thus preventing financial strain and defaults. Additionally, or alternatively, the dynamic adjustment engine 125 may adjust the one or more plans for unforeseen circumstances, such as medical bills or car repairs, thus maintaining affordability. Additionally, or alternatively, the dynamic adjustment engine 125 may recognize (e.g., identify) improvements in credit worthiness and may offer more favorable plan options based on the recognition, which may ensure long-term sustainability and affordability for customers, fostering trust and positive relationships with lenders.

By tailoring plans to customers, the system 100 may support customers staying within their means and avoiding financial strain (e.g., increased affordability). Additionally, or alternatively, by dynamically adjusting plans and risk predictions, the system 100 may reduce (e.g., minimize) defaults (e.g., risk), benefiting both customers and lenders. Thus, the system 100 (e.g., AI-powered personalized payment plan system) may present an approach to responsible lending (e.g., avoiding predatory lending) and financial inclusion (e.g., broader access to credit for individuals with limited credit history based on alternative data evaluation). By tailoring plans to individual circumstances, predicting repayment risks with high accuracy, adapting to dynamic situations, or any combination thereof, the system fosters customer satisfaction (e.g., personalized options, transparency, and control), promotes financial well-being (e.g., customer well-being), and benefits diverse industries. The techniques described herein may support further development and refinement, thus enabling innovation and responsible financial solutions.

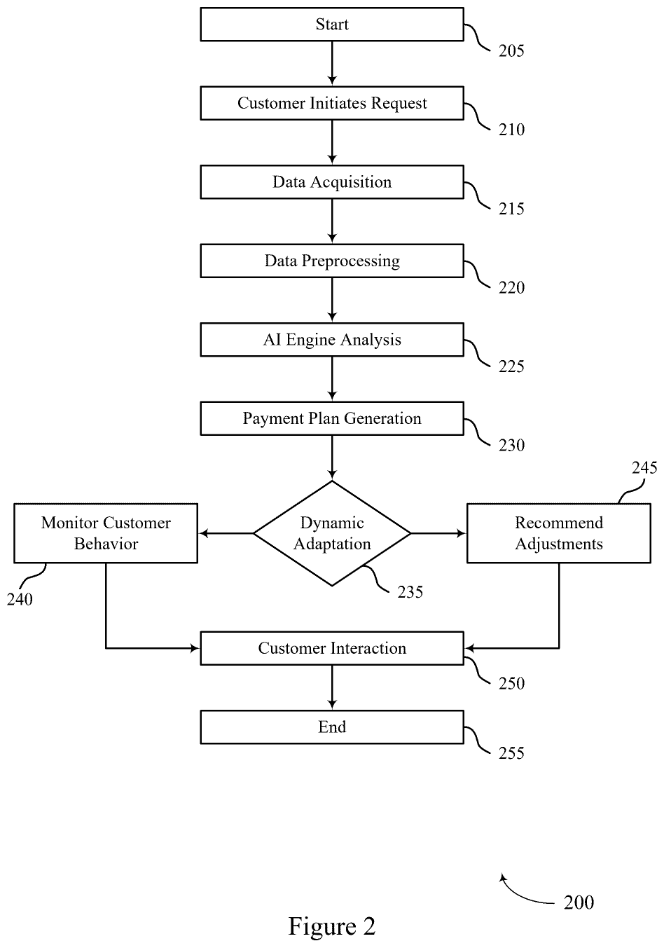

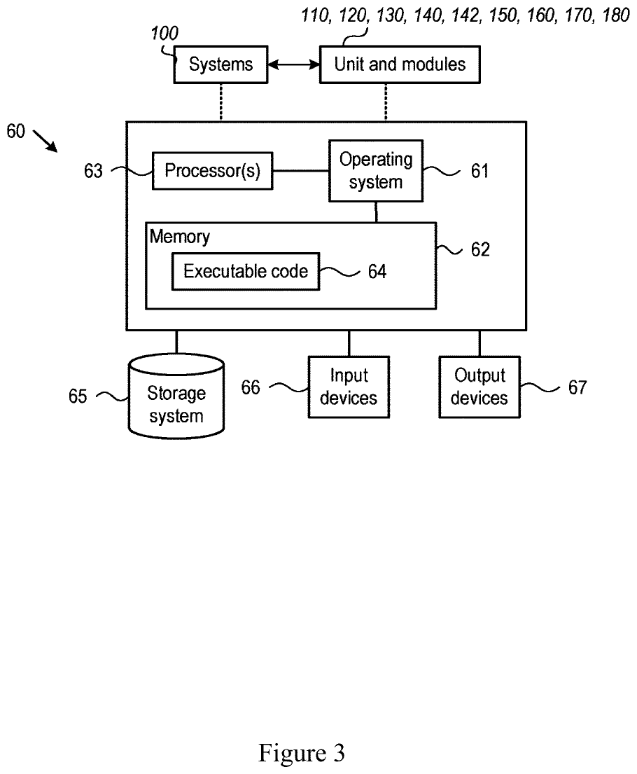

FIG. 2 is a high-level flowchart of a process 200 illustrating a non-limiting example for generating and managing personalized payment plans utilizing AI, according to some embodiments of the invention. This non-limiting example is schematic and simplified, and does not limit the scope of the invention. The process 200 may be implemented by the system (e.g., the system 100 of FIG. 1). The process 200 may be implemented by aspects of the system 100 of FIG. 1 or by the controllers 60 of FIG. 3.

In some cases, a system (e.g., the system 100) may integrate with existing payment platforms and may utilize secure data access protocols to protect customer privacy. For example, after (e.g., upon) purchase, customers may securely input their financial information and preferences into a user-interface and, as described herein, the system (e.g., AI analysis engine 115) may analyze the input financial information and preferences to generate multiple personalized payment plan options tailored to the financial information and preferences (e.g., the needs of the customer). Customers may then choose, adjust, monitor, or any combination thereof, a chosen payment plan (e.g., from the multiple personalized payment plan options) through the user interface, receiving real-time updates and notifications.

For example, at 205 a customer may start the process 200 depicted in FIG. 2. At 210, the customer may initiate a request (e.g., via the user interface 105). For example, the customer may apply for a loan, make a purchase requiring a payment plan, or the like thereof. At 215, a system, such as the system 100 depicted in FIG. 1, may perform data acquisition (e.g., using the data acquisition module 110). For example, with customer (e.g., user) consent, the system may securely collect customer data through one or more authorized channels. The customer data may include financial information (e.g., bank details with anonymization, income statements, credit worthiness scores, existing debts, etc.), one or more spending habits (e.g., categorized transaction history), demographic information (e.g., age, income level, employment status), or any combination thereof.

At 220, the system (e.g., the data acquisition module 110) may perform data preprocessing. For example, the system may clean, normalize, engineer, or any combination thereof, the collected (e.g., acquired) customer data for utilization (e.g., for optimal utilization).

At 225, the system (e.g., the AI analysis engine 115, the risk prediction module 120) may perform AI engine analysis (e.g., powered by machine learning, supervised learning models, deep learning models). For example, the system may analyze the preprocessed customer data. Additionally, or alternatively, the system may identify one or more patterns, one or more relationships, or both, between one or more customer financial characteristics and successful payment plan completion. In some cases, the system may extract the one or more relationships (e.g., complex relationships) within the customer data.

At 230, the system (e.g., the plan generation module 130, using the AI engine), may generate multiple (e.g., a spectrum of) potential (e.g., candidate) payment plan options tailored to the customer's financial situation (e.g., unique financial situation). The plans may be generate based on (e.g., optimized for) affordability (e.g., comfortably manageable within the customer's budget), successful repayment probability (e.g., high, or threshold, likelihood of completion), or both.

In some cases, the system may enable a dynamic adaptation module (e.g., the dynamic adjustment engine 125). If the dynamic adaptation module is not enabled (e.g., not depicted), the system may, at 255, end the process 200. Conversely, if the dynamic adaptation module is enabled (e.g., as depicted in FIG. 2), the system may, at 235, perform dynamic adaptation. The dynamic adaptation may include monitoring customer behavior (e.g., at 240), recommending adjustments (e.g., if enabled, at 245), or both. For example, at 240, the system may continuously monitor the customer's financial circumstances, spending patterns, or both, in real time to track changes in income, expenses, unexpected financial events, or any combination thereof. Additionally, or alternatively, at 245, the system may, based on real-time data, recommend adjustments to an existing payment plan to support (e.g., ensure) affordability, a high success rate of repayment, or both.

In some cases, at 250, the system may (e.g., via customer interaction) present the multiple personalized payment plan options to the customer through a user interface (e.g., user-friendly interface, the user interface 105). For example, the system (e.g., via the user interface) may allow the customer to view plan details, track progress towards completion, receive notifications regarding potential adjustments, or any combination thereof.

The following non-limiting examples of generating and managing personalized payment plans utilizing artificial intelligence are merely exemplary embodiments of the present disclosure and do not limit the scope of the invention.

In some embodiments, the system may enable a resident (e.g., customer) to address unexpected expenses. For example, the resident may may experience a sudden car repair or medical bill, impacting their ability to pay rent on time. The system, upon analyzing the resident's past payment history and financial stability, may generate a short-term payment plan that allows the resident to spread the rent payment over multiple (e.g., a few) installments.

In another embodiment, the system may enable a resident to address seasonal fluctuations in income. For example, the resident may work in a seasonal industry with a fluctuating income. The system, with access to the resident's historical payment patterns and income trends, may create (e.g., generate) a payment plan that adjusts a monthly rent amount based on the resident's anticipated income for a given (e.g., specific) month. By adjusting the rent amount based on the resident's anticipated income, the system may ensure affordability during lean months (e.g., low income months) and reduce (e.g., minimizes) late payments.

In another embodiment, the system may supper a resident during lease renewal. For example, a resident may desire to renew their lease but may face a rent increase. The system, factoring in the resident's on-time payment history and positive contribution to the community, may generate a personalized payment plan with a reduced rent increase spread over a new lease term. By generating the personalized payment plan with the reduced rent increase spread over the new lease term, the system may incentivizes long-term residents, foster positive relationships between residents and property management, or both.

In another embodiment, the system may assist new residents. For example, a new resident with a limited credit history may struggle to secure a security deposit (e.g., traditional security deposit). The system, analyzing the resident's income and employment verification, may create a payment plan that allows the resident to spread the security deposit amount over several months, easing the financial burden of move-in costs and promoting resident retention.

In another embodiment, the system may tailor payment options. For example, a resident may prefer to make bi-weekly rent payments to better align with their pay schedule. The system may accommodate this preference (e.g., to make bi-weekly rent payments) and generate a bi-weekly payment plan, enhancing convenience and ensuring on-time payments.

Elements from FIGS. 1 and 2 may be combined in any operable combination, and the illustration of certain elements in certain figures and not in others merely serves an explanatory purpose and is non-limiting.

Aspects of the present invention are described above with reference to flowchart illustrations and/or block diagrams of methods, apparatus (systems) and computer program products according to embodiments of the invention. It will be understood that each portion of the flowchart illustrations and/or block diagrams, and combinations of portions in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram or portions thereof.

These computer program instructions may also be stored in a computer readable medium that can direct a computer, other programmable data processing apparatus, or other devices to function in a pailicular manner, such that the instructions stored in the computer readable medium produce an article of manufacture including instructions which implement the function/act specified in the flowchart and/or portion diagram or pollions thereof.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram or portions thereof.

FIG. 3 is a high-level block diagram of exemplary controllers 60, which may be used with embodiments of the present invention. Any of the systems (e.g., the system 100, the system described herein), units or modules thereof (130, 140, 142, 150, 160, 170, 180) as well as any of stages of the method 200 may be implemented using controllers 60 or parts thereof such as processor(s). Controller(s) 60 may include one or more controller or processor 63 that may be or include, for example, one or more central processing unit processor(s) (CPU), one or more Graphics Processing Unit(s) (GPU or general-purpose GPU-GPGPU), a field-programmable gate array (FPGA), an application-specific integrated circuit (ASIC), a digital signal processor (DSP), a microprocessor, a chip, a microchip, an integrated circuit (IC), or any other suitable multi-purpose or specific processor, controller or computational device, an operating system 61, a memory 62, a storage 65, input devices 66 and output devices 67.

Operating system 61 may be or may include any code segment designed and/or configured to perform tasks involving coordination, scheduling, arbitration, supervising, controlling, or otherwise managing operation of controller(s) 60, for example, scheduling execution of programs. Memory 62 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long-term memory unit, or other suitable memory units or storage units. Memory 62 may be or may include a plurality of possibly different memory units. Memory 62 may store for example, instructions to carry out a method (e.g., code 64), and/or data such as user responses, interruptions, etc.

Executable code 64 may be any executable code, e.g., an application, a program, a process, task or script. Executable code 64 may be executed by controller 63 possibly under control of operating system 61. For example, executable code 64 may when executed cause the production or compilation of computer code, or application execution such as VR execution or inference, according to embodiments of the present invention. Executable code 64 may be code produced by methods described herein. For the various modules and functions described herein, one or more computing devices and/or components of controller(s) 60 may be used. Devices that include components similar or different to those included in controller(s) 60 may be used and may be connected to a network and used as a system. One or more processor(s) 63 may be configured to carry out embodiments of the present invention by, for example, executing software or code.

Storage 65 may be or may include, for example, a hard disk drive, a floppy disk drive, a Compact Disk (CD) drive, a CD-Recordable (CD-R) dlive, a universal serial bus (USB) device or other suitable removable and/or fixed storage unit. Data such as instructions, code, VR model data, parameters, etc. may be stored in a storage 65 and may be loaded from storage 65 into a memory 62 where it may be processed by controller 63. In some embodiments, some of the components shown in FIG. 4 may be omitted.

Input devices 66 may be or may include for example a mouse, a keyboard, a touch screen or pad or any suitable input device. It will be recognized that any suitable number of input devices may be operatively connected to controller(s) 60 as shown by block 66. Output devices 67 may include one or more displays, speakers and/or any other suitable output devices. It will be recognized that any suitable number of output devices may be operatively connected to controller(s) 60 as shown by block 67. Any applicable input/output (I/O) devices may be connected to controller(s) 60, for example, a wired or wireless network interface card (NIC), a modem, printer or facsimile machine, a universal serial bus (USB) device or external hard drive may be included in input devices 66 and/or output devices 67.

Embodiments of the disclosure may include one or more article(s) (e.g., memory 62 or storage 65) such as a computer or processor non-transitory readable medium, or a computer or processor non-transitory storage medium, such as for example a memory as disclosed herein, a disk drive, or a USB flash memory, encoding, including or storing instructions, e.g., computer-executable instructions, which, when executed by a processor or controller, carry out methods disclosed herein.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A system for generating and managing personalized payment plans, comprising:
a data acquisition module configured to collect customer data, wherein the customer data comprises financial information, one or more spending habits, demographic information, or any combination thereof;
a preprocessing module configured to normalize the customer data;
an AI analysis engine configured to:
analyze the preprocessed customer data;
generate a plurality of candidate payment plans; and
adjust the plurality of candidate payment plans based on affordability, a probability of successful repayment, or both;
a dynamic adaptation module configured to monitor customer behavior, one or more financial circumstances, or both, in real-time; and
a user interface configured to:
display the plurality of candidate payment plans;
display progress towards completion of a payment plan from the plurality of candidate payment plans; and
receive one or more notifications of one or more recommended adjustments to the payment plan.

2. The system of claim 1, wherein the financial information comprises one or more bank account details, one or more income statements, one or more creditworthiness scores, one or more existing debt obligations, or any combination thereof.

3. The system of claim 1, wherein the one or more spending habits comprise a transaction history categorized by one or more spending patterns.

4. The system of claim 1, wherein the demographic information comprises age, income level, employment status, or any combination thereof.

5. The system of claim 1, wherein the AI analysis engine comprises one or more supervised learning algorithms trained on one or more historical data sets, and wherein the one or more historical data sets comprise a plurality of customer profiles and a respective repayment outcome for each customer profile of the plurality of customer profiles.

6. The system of claim 1, wherein the AI analysis engine comprises one or more deep learning models configured to extract one or more relationships within the customer data.

7. The system of claim 1, wherein the dynamic adaptation module is configured to generate the one or more recommended adjustments to the payment plan based at least in part on one or more changes in spending habits, based at least in part on one or more income fluctuations, based at least in part on one or more financial events, or any combination thereof.

8. The system of claim 1, further comprising:
a security module configured to:
secure the customer data in accordance with one or more financial regulations, one or more data privacy regulations, or both.

9. The system of claim 8, wherein the security module is configured to secure the customer data using one or more encryption techniques.

10. The system of claim 1, wherein the user interface is accessible through a web application, a mobile application, or both.

11. A method for generating and managing personalized payment plans, comprising:
acquiring customer data, wherein the customer data comprises financial information, one or more spending habits, demographic information, or any combination thereof;
preprocessing the customer data;
analyzing the preprocessed customer data using an artificial intelligence (AI) analysis engine;
generating a plurality of candidate payment plans based at least in part on the analyzed customer data;
adjusting the plurality of candidate payment plans based on affordability, a probability of successful repayment, or both;
displaying the plurality of candidate payment plans to a customer;
monitoring customer behavior, one or more financial circumstances, or both, in real-time; and
displaying one or more recommended adjustments to a payment plan from the plurality of candidate payment plans based at least in part on the customer behavior, the one or more financial circumstances, or both.

12. The method of claim 11, wherein the financial information comprises one or more bank account details, one or more income statements, one or more credit worthiness scores, one or more existing debt obligations, or any combination thereof.

13. The method of claim 11, wherein the one or more spending habits comprise a transaction history categorized by one or more spending patterns.

14. The method of claim 11, wherein the demographic information comprises age, income level, employment status, or any combination thereof.

15. The method of claim 11, further comprising:
securing the customer data in accordance with one or more financial regulations, one or more data privacy regulations, or both.

16. The method of claim 11, wherein displaying the plurality of candidate payment plans to the customer comprises:
displaying a message enabling the customer to select the payment plan from the plurality of candidate payment plans.

17. A computer-readable medium storing instructions executable by a processor, the instructions executable by the processor to:
acquire customer data, wherein the customer data comprises financial information, one or more spending habits, demographic information, or any combination thereof;
pre-process the customer data;
analyze the preprocessed customer data using an artificial intelligence (AI) analysis engine;
generate a plurality of candidate payment plans based at least in part on the analyzed customer data;
adjust the plurality of candidate payment plans based on affordability, a probability of successful repayment, or both;
display the plurality of candidate payment plans to a customer;
monitor customer behavior, one or more financial circumstances, or both, in real-time; and
display one or more recommended adjustments to a payment plan from the plurality of candidate payment plans based at least in part on the customer behavior, the one or more financial circumstances, or both.
